(19) United States
(12) Patent Application Publication
(10) Pub. No.: US 2024/0123849 A1
(43) Pub. Date: Apr. 18, 2024

(54) Energy Storage System with Fuel Gas

(71) Applicant: Gravitricity Ltd, Edinburgh (GB)

(72) Inventors: Martin Wright, London (GB); Peter Fraenkel, London (GB)

(21) Appl. No.: 18/276,521

(22) PCT Filed: Feb. 9, 2022
(86) PCT No.: PCT/EP2022/053162

§ 371 Date: Aug. 9, 2023

(30) Foreign Application Priority Data
Feb. 9, 2021 (GB) 2101753.8

(51) Int. Cl. B60L 53/30; B60L 53/53; B60L 53/54; B60L 53/56; F03G 3/00; H01M 8/04029; H01M 8/04082; H01M 8/04089; H02J 15/00

(52) U.S. Cl. CPC B60L 53/30; B60L 53/53; B60L 53/54; B60L 53/56; F03G 3/094; H01M 8/04029; H01M 8/04089; H01M 8/04201; H02J 15/00; H01M 2250/10

(57) ABSTRACT

An energy storage system having a first, gravity-based energy storage sub-system having at least one weight movable between a first upper position and a second lower position defining a vertical displacement and a second energy storage sub-system comprising a vessel for storage of a pressurized fuel gas has an electrical input/output connection with an external power system and at least one of: a fuel gas inlet for supply of a fuel gas to the energy storage system from an external fuel gas supply or network; and a fuel gas outlet for supply of a fuel gas from the energy storage system to an external fuel gas user or network, and/or has at least one of: a gas to power conversion arrangement for converting energy from fuel gas to electrical energy for storage in the first energy storage sub-system or export to an external power system via the electrical output connection; and a power to gas conversion arrangement for converting electrical energy to a fuel gas for storage in the second energy storage sub-system or export to an external fuel gas user or network via a fuel gas outlet, where a control system is configured to control cooperative or complimentary operation of the first and second energy storage sub-systems according to the requirements of the external power system and/or external fuel gas network or user. The system as defined enable energy storage (charge) and discharge of the system linked to an external power system such as an electricity grid to store energy using a gravity-based storage arrangement to make use of its rapid response time and rapid charge/discharge speed, while providing an enhanced capacity of energy storage.

### FIELD OF THE INVENTION

This invention relates generally to the field of energy storage and in particular to a system, apparatus and method of storing energy such as from an electrical power system or gas network and supplying electricity or fuel gas.

### BACKGROUND OF THE INVENTION

The transition to low and zero-carbon energy systems and increasing dependency on renewable energy leads to greater variability between the timing of available supply and demand for energy, compared with existing fossil-fuel based systems. A consequence of this is that storage of energy, especially energy derived from renewable resources, is likely to play an increasingly important role.

The transition to low and zero carbon systems includes transitioning to low carbon electricity, with which there has been considerable progress to date, but also to space heating and transport which represent a continuing challenge.

The transition of space heating to low carbon solutions is being pursued through electrically-facilitated heating (air source and ground source heat pumps), a potential future green gas (e.g. biogas or green hydrogen) and district heating schemes (from low carbon sources).

Land-based transport is in transition to low carbon systems, including, for example, electric vehicles and hydrogen electric vehicles as well as hydrogen powered trains (on non-electrified routes).

Gravity-based energy storage systems are increasingly being recognised as one method of energy storage and grid balancing that is reliable and efficient. Large scale pumped-hydro is well known, but recently innovations in raising and lowering weights (including in shafts or holes in the ground), and in particular weight and cable systems are offering efficiencies in energy storage as well as benefits in energy capacity to meet local and national grid needs and improved response times.

For example, UK patent no 2509437 describes an energy storage system having a weight suspended from a cable within a shaft to generate electrical energy during lowering of the weight into a shaft in the ground and to consume, for storage, electrical energy during lifting of the weight through the shaft.

To be economically advantageous and provide high quality power receipt from or supply to an external power system, an energy storage system is advantageously providing a rapid response (i.e. short response time and the capability for modulating the output to meet demand), a large energy capacity and a continuous input/output across that full capacity.

The present inventors have identified improvements in energy storage systems which address the shortcomings of such a system and which improve on the existing art.

### Problem to be Solved by the Invention

There is a need for improvements in energy storage systems to provide larger capacity and higher quality energy storage via cable and weight gravity-based systems. There is also a need to address energy storage for power, heat and transport.

It is an object of this invention to provide an energy storage system which enables an enhanced energy storage capacity using a gravity-based energy storage system while providing extended duration energy storage or supply.

It is an object of this invention to provide an energy storage system for multiple purposes, such as for the supply of power for electrical supplies and for heating and for transport.

### SUMMARY OF THE INVENTION

In accordance with a first aspect of the invention, there is provided an energy storage system comprising:
a first energy storage sub-system comprising a gravity-based energy storage system comprising at least one weight movable between a first upper position and a second lower position, the first upper and second lower positions defining a vertical displacement for the or each weight;
a second energy storage sub-system comprising a vessel for storage of a pressurized fuel gas;
an electrical input connection and an electrical output connection with an external power system; and
at least one of:
   a fuel gas inlet for supply of a fuel gas to the energy storage system from an external fuel gas supply or network; and
   a fuel gas outlet for supply of a fuel gas from the energy storage system to an external fuel gas user or network; and/or
at least one of:
   a gas to power conversion arrangement for converting energy from fuel gas to electrical energy for storage in the first energy storage sub-system or export to an external power system via the electrical output connection; and
   a power to gas conversion arrangement for converting electrical energy to a fuel gas for storage in the second energy storage sub-system or export to an external fuel gas user or network via a fuel gas outlet;
      wherein the energy storage system further comprises a control system for controlling cooperative or complimentary operation of the first and second energy storage sub-systems according to the requirements of the external power system and/or external fuel gas network or user.

In a second aspect of the invention, there is provided an energy storage system comprising:
a first energy storage sub-system comprising a gravity-based energy storage system comprising at least one weight movable between a first upper position and a second lower positions through a volume (e.g. as defined by a shaft formed in the ground), the first upper and second lower positions defining a vertical displacement for the or each weight; and
a second energy storage sub-system comprising a pressurized fuel gas storage vessel, the vessel defining a fuel-gas storage volume which encompasses the volume defined by the first energy storage sub-system.

In a third aspect of the invention, there is provided an energy storage system comprising:
a first energy storage sub-system comprising a gravity-based energy storage system comprising at least one weight movable between a first upper position and a second lower position through a shaft (or other vertical passage) formed in the ground, the first upper and second lower positions defining a vertical displacement for the or each weight; and
a thermal energy capture and/or storage sub-system comprising heat capture elements disposed within or surrounding the shaft of the first energy storage sub-system to capture thermal energy from within or the surroundings of the shaft.

In a fourth aspect of the invention, there is provided a method for the storage and supply of energy to and from external energy systems, the method comprising providing an energy storage system as defined above, operating the control system to control the storage of electrical energy from an external power source or network as potential energy by the raising of weights in a first storage sub-system or chemical energy by conversion of the electrical energy to a fuel gas by way of the power to gas conversion arrangement and storing the resultant fuel gas in the second energy storage sub-system to control the storage of energy from fuel gas from an external fuel gas supplier or network as compressed fuel gas by feeding the fuel gas into the second energy storage arrangement or storing the supplied fuel gas as potential energy by conversion of the fuel gas to electrical energy using a gas to power conversion arrangement and storing the energy as potential energy by the raising of weights in a first storage sub-system in accordance with the energy storage requirements of external gas and power networks or suppliers and in dependence of the fuel gas and electrical energy storage capacity of the first and second energy storage sub-systems and the pre-defined or predicted fuel gas and electrical energy output requirements.

### Advantages of the Invention

The energy storage system and method of the invention enable energy storage (charge) and discharge linked to an external power system such as an electricity grid to store energy using a gravity-based storage arrangement to make use of its rapid response time and rapid charge/discharge speed, while providing an enhanced capacity of energy storage.

### BRIEF DESCRIPTION OF THE DRAWINGS

FIG. 1 illustrates the process flows and inter-relationships between sub-systems of an energy storage system according to one embodiment of the invention;

FIG. 2 is a diagrammatic representation in cross-sectional view of an energy storage system of another embodiment of the invention; and

FIG. 3 is a diagrammatic representation in cross-sectional view of an energy storage system of a still further embodiment of the invention.

### DETAILED DESCRIPTION OF THE INVENTION

The invention according to the first aspect is an energy storage system. It comprises a first energy storage sub-system and a second energy storage sub-system and optionally a thermal energy storage sub-system and further energy storage sub-systems.

The first energy storage sub-system comprises a gravity-based energy storage system comprising at least one weight movable between a first upper position and a second lower position, the first upper and second lower positions defining a vertical displacement for the or each weight.

The second energy storage sub-system comprising a vessel for storage of a pressurized fuel gas.

The system is provided with an electrical input connection and an electrical output connection with an external power system and at least one of a fuel gas inlet for supply of a fuel gas to the energy storage system from an external fuel gas supply or network and a fuel gas outlet for supply of a fuel gas from the energy storage system to an external fuel gas user or network and/or at least one of a gas to power conversion arrangement for converting energy from fuel gas to electrical energy for storage in the first energy storage sub-system or export to an external power system via the electrical output connection and a power to gas conversion arrangement for converting electrical energy to a fuel gas for storage in the second energy storage sub-system or export to an external fuel gas user or network via a fuel gas outlet.

The energy storage system further comprises a control system for controlling cooperative or complimentary operation of the first and second energy storage sub-systems according to the requirements of the external power system and/or external fuel gas network or user.

The first energy storage sub-system preferably comprises a passageway or shaft, preferably a vertical passageway or shaft, through which the at least one weight is movable between the first upper position and second lower position. The vessel of the second energy storage sub-system preferably comprises the passageway or shaft of the first energy storage sub-system. The passageway or shaft is preferably formed in the ground and may be, for example, an adapted existing mine shaft or a newly sunk bespoke shaft.

Preferably, the gravity-based energy storage sub-system comprises a winch and cable arrangement comprising at least one winch disposed at or in relation to a shaft opening at the top of a shaft, whereby a cable may be wound and unwound by the winch to enable raising and lowering the weight, and wherein the winch and cable arrangement is disposed within the vessel. The cables may be of any suitable form, such as steel cables or synthetic cables, but preferably (especially when used in a storage vessel of a fuel gas such as hydrogen) may be of a synthetic material or rope which is not subject to embrittlement by the presence of hydrogen.

Preferably the vessel comprises a cap or dome disposed and sealed over the top of the shaft. The shaft may be lined, and preferably comprises a lining or lining coating that is resistant to embrittlement or corrosion by hydrogen as the fuel gas.

The winch and cable arrangement may be driven by any suitable means. Even when disposed within a fuel gas storage vessel, the winch and cable arrangement may be driven by well-sealed electrical motors or preferably by hydraulic or pneumatic driven systems, bearing in mind the need to avoid sparks that could cause ignition of a fuel gas should any air have leaked into the enclosure or vessel.

Preferably, the winch and cable arrangement is hydraulically driven by an hydraulic drive system, when the first energy storage sub-system is receiving power or charging, and hydraulically drives an hydraulic generator, when the first energy storage sub-system is discharging power or discharging. The hydraulic drive system may be configured to have a motor or generator disposed outside of the vessel of the second energy storage sub-system and wherein hydraulic drive feed and return pipes linking the motor or generator with a corresponding hydraulic motor/pump inside the vessel adjacent the winch(es) to operate the winch and cable arrangement. Hydraulic drive feed and return pipes preferably pass through an aperture formed in the vessel wall, wherein a seal is formed at the vessel wall around the pipes to prevent leakage of pressurized gas from the interior of the vessel to the surrounding atmosphere.

Preferably, the system further comprises a thermal capture and/or storage sub-system configured to capture thermal energy from within and/or material surrounding the vessel of the second energy storage sub-system, e.g. by way of one or more heat exchange elements or members. Optionally thermal capture and/or storage sub-system comprises a heat pump arrangement, which may be located some distance from the shaft or vessel of the first or second energy storage sub-systems and connected to the thermal capture means or heat exchange members by feed and return pipes for carrying a heat carrying fluid.

Optionally, the thermal capture and/or storage sub-system is configured to provide heating and/or cooling to the fuel gas storage sub-system vessel via a thermal exchange element to maintain the temperature of the fuel gas storage vessel within pre-defined operational limits.

The fuel gas may be hydrogen or methane or other commercially useful gas, such as propane or natural gas, that may readily be compressed and stored. Preferably, the fuel gas is hydrogen. The fuel gas, and in particular hydrogen, may be stored in the vessel at any suitable pressure, such as a pressure of up to 300 bar, preferably up to 100 bar, e.g. at a maximum of about 85 bar. In any case, the pressure in the vessel when at capacity is preferably at least 30 bar.

In one embodiment, the first energy storage sub-system comprises a multi-weight gravity-based energy storage arrangement comprising a shaft (or other vertical passage) and multiple weights configured for lowering and raising through the shaft by a transporter (e.g. a winch and cable arrangement). In one such embodiment, multiple weights (e.g. two) are provided side by side and follow non-overlapping paths under the control of respective winch arrangements. In this embodiment, the winches may remain connected with their respective weights via the cable. In another such embodiment, the two or more weights have overlapping or the same paths and, according to this embodiment, may be stored in storage positions at the top and/or bottom of the shaft. For example, a capped volume at the top of the shaft/vessel may include a weight storage area. Such a system according to this latter embodiment can be characterized by having a primary energy capacity by discontinuities in power flow capability.

In this embodiment, there is preferably a third energy storage sub-system configured for cooperative and/or complimentary operation with the first energy storage sub-system in order to provide the energy storage system with one or more of:
i) a continuous input or output power during a charge or discharge cycle across at least two energy events of the first energy storage sub-system which energy events are separated by a discontinuity in output from the first energy storage sub-system;
ii) an enhanced or faster system start-up response, whereby the system may reach a predefined or desired power input/output level by responding to a requirement of an external power system using both the primary energy storage arrangement and the secondary energy storage arrangement simultaneously for the requirement of the external power system;
iii) an enhanced system discharge halting capability, whereby the system may rapidly halt discharge to an external power system without a power output surge above a desired system power output, the power output surge being directed for temporary energy storage in the secondary energy storage arrangement; and
iv) a power surge input/output capability, whereby for short durations, the system can input or output power at a power level above a power rating of the energy storage system or the primary power storage arrangement.

In such a system, the system may have a system power rating being the maximum power it can input/output to/from an external power system across the extent of the system energy capacity. The third energy storage sub-system preferably has a tertiary power rating at least equal to the system power rating and has a tertiary energy capacity at least equal to a maximum energy gap arising from the discontinuous nature of the first energy storage sub-system power input/output when the system power input/output is constant at the system power rating. Preferably, the tertiary energy capacity is up to 10 times the maximum energy gap, preferably up to 5 times the maximum energy gap, more preferably up to 2 times the maximum energy gap and optionally up to 1.8 or 1.5 times the maximum energy gap. Preferably, the primary power rating is greater than the tertiary power rating.

A third energy storage sub-system is preferably selected from a battery, a capacitor or supercapacitor, a compressed air energy storage system, a flywheel or a second gravity-based energy storage system.

The system of the present invention preferably has a fuel gas outlet for supply of a fuel gas from the second energy storage sub-system to a gas network pipeline.

Optionally, the system comprises a vehicle charging and/or refuelling station which comprises an eV charging station and/or a fuel gas vehicle refuelling stations, the vehicle charging and/or refuelling station being supplied from the energy storage system via a vehicle charge station electrical supply connection and/or a refuelling fuel gas outlet connection.

In one embodiment, and in another aspect, an energy storage system comprises a first energy storage sub-system and second energy storage sub-system. The first energy storage sub-system comprises a gravity-based energy storage system comprising at least one weight movable between a first upper position and a second lower positions through a volume (e.g. as defined by a preferably vertical passageway or shaft, typically formed in the ground), the first upper and second lower positions defining a vertical displacement for the or each weight. The second energy storage sub-system comprises a pressurized fuel gas storage vessel, the vessel defining a fuel-gas storage volume which encompasses the volume defined by the first energy storage sub-system. The fuel gas may be any suitable fuel gas, such as methane, natural gas or other fuel gas, but is preferably hydrogen. The fuel gas may be stored in the vessel at suitable pressures as are described above.

In embodiments of the invention described herein, comprising a first energy storage sub-system comprising a gravity-based energy storage system and a second energy storage sub-system comprising a vessel for storage of a pressurized fuel gas, such as hydrogen, it is preferable that the first and second energy storage sub-systems occupy a shared volume, preferably a volume within the vessel accommodating at least the volume required for the raising and lowering of weights of the first energy storage sub-system. Preferably, the first energy storage sub-system comprises winches (ideally hydraulically driven) and cables for raising and lowering weights through a vertical path volume and preferably the winches, cables and weights and the vertical path volume are within the vessel of the second energy storage sub-system. Preferably the vessel, which defines the vertical passage for the first energy storage sub-system and the fuel gas storage volume of the second energy storage sub-system is disposed such that at least a portion is under-ground, e.g. formed by lining a shaft in the ground. The vessel may comprise a cap, e.g. a dome, formed over a lined shaft (e.g. cylindrical shaft), e.g. over a rim or other upper rim flange of a shaft. Optionally, the entire shaft and preferably the entire vessel is disposed underground. It is particularly beneficial to provide the vessel of the fuel gas storage sub-system (the second energy storage-sub-system) as a shared volume with the shaft of the first energy storage sub-system, because of the cost saving of using the same infrastructure (i.e. shaft sunk in the ground) and the impact that can have on the levelized cost of storage in addition to the advantage of ground mass, if intimately in contact with the pressure vessel, adding to the structural integrity of the vessel, e.g. to its resistance to bursting. Thus, the quantity of material or lining material (e.g. steel) required to form the vessel may be significantly reduced while achieving the required to achieve adequate structural integrity, which can lead to a reduction in cost. Further, from the point of view of fire and explosion risk when storing pressurised fuel gas, by providing the vessel partially or entirely underground in this way, the ground will tend to contain a fire or explosion and minimise damage to any surrounding property (or personnel).

In another preferred embodiment, and a further aspect, of the invention, an energy storage system comprises a first energy storage sub-system and a thermal energy capture and/or storage sub-system. According to this embodiment/aspect, the first energy storage sub-system may comprise a gravity-based energy storage system comprising at least one weight movable between a first upper position and a second lower position through a shaft (or other preferably vertical passage) preferably formed in the ground, the first upper and second lower positions defining a vertical displacement for the or each weight. The thermal energy capture and/or storage sub-system preferably comprises heat capture elements disposed within or surrounding the shaft of the first energy storage sub-system to capture thermal energy from within or from the surroundings of the shaft.

There is further provided a method for the storage and supply of energy to and from external energy systems, the method comprising providing an energy storage system as defined above, operating the control system to control the storage of electrical energy from an external power source or network as potential energy by the raising of weights in a first storage sub-system or chemical energy by conversion of the electrical energy to a fuel gas by way of the power to gas conversion arrangement and storing the resultant fuel gas in the second energy storage sub-system to control the storage of energy from fuel gas from an external fuel gas supplier or network as compressed fuel gas by feeding the fuel gas into the second energy storage arrangement or storing the supplied fuel gas as potential energy by conversion of the fuel gas to electrical energy using a gas to power conversion arrangement and storing the energy as potential energy by the raising of weights in a first storage sub-system in accordance with the energy storage requirements of external gas and power networks or suppliers and in dependence of the fuel gas and electrical energy storage capacity of the first and second energy storage sub-systems and the pre-defined or predicted fuel gas and electrical energy output requirements.

In each of the above aspects, the energy storage system preferably comprises a control system for controlling cooperative or complimentary operation of the first and second energy storage sub-systems and optional thermal energy capture and/or storage systems and optional further energy storage sub-systems according to the requirements of the external power system and/or external fuel gas network or user. This includes any conversion of the form of energy as between two or more sub-systems, to ensure a desired or predicted service is available (e.g. provision of electrical power for rapid supply or capacity for receiving electrical energy for storage). Preferably, the control system, which typically includes a control software operating on a cup, is configured to minimise the number of energy conversions, especially between sub-systems, while maintaining a desired service in view of the relative capacities for storage available.

The invention will now be described in more detail, without limitation, with reference to the accompanying Figures.

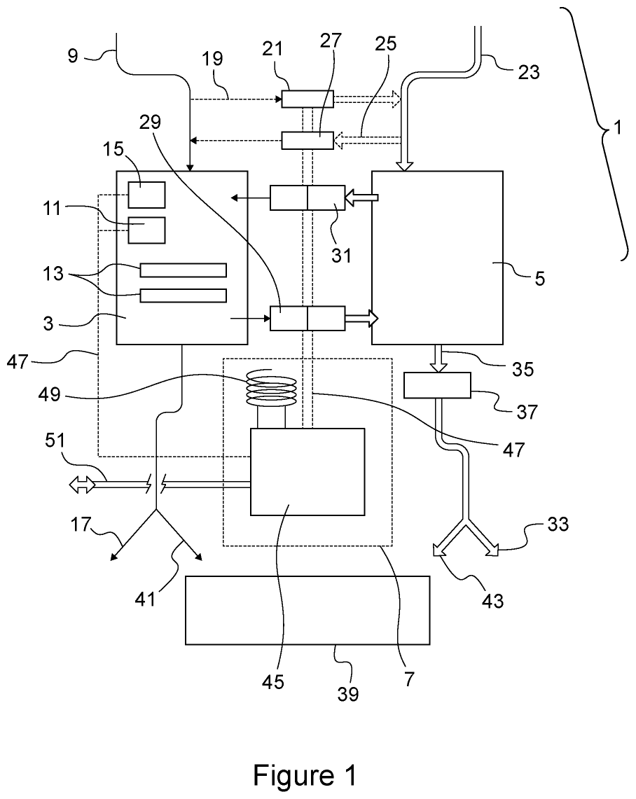

In FIG. 1, an energy storage system 1 according to an embodiment of the invention comprises a multi-weight gravity energy storage sub-system 3 and a compressed hydrogen (as a preferred fuel gas) storage sub-system 5. The system optionally further comprises a thermal energy capture and storage sub-system 7.

Power may be supplied to the energy storage system by way of external power grid input connection 9 via which power may be supplied to the gravity energy storage sub-system 3, as a first energy storage sub-system. Gravity-based energy storage sub-system 3 comprises a winch arrangement 11 configured to raise and lower weights 13 through a vertical passage or shaft (not shown) via cables (not shown), which may be synthetic cables, depending upon whether it is a storage/charge event or discharge event in the gravity energy storage sub-system 3. The winch arrangement 11 is driven by a motor/generator arrangement 15 using electrical energy that is to be stored in order to lift the weights 13 and motor/generator arrangement 15 acts as a generator to generate electrical energy for supply, for example, to an external grid via a system power output connection 17 during a discharge event to meet an external grid requirement. In cases where the winch and weight arrangement is disposed within the vessel of the second energy storage sub-system and thus in a fuel gas atmosphere, it is preferred to keep electrical components either sealed or preferably external to the pressure vessel with the fuel gas in it. According to this embodiment, the power units for the winches when enclosed in a fuel gas environment will preferably be hydraulic driven from outside the pressurized enclosure by an externally placed electrical hydraulic pump/motor.

A second energy storage sub-system is provided by a fuel gas storage sub-system 5, which is preferably a hydrogen storage sub-system 5. The hydrogen storage sub-system 5 is for storing compressed hydrogen gas in a storage volume defined by a vessel (not shown) which preferably includes the volume of the vertical passage or shaft through which the weights 13 in the gravity-based energy storage sub-system 3 are raised and lowered. One advantage of this single volume is the sharing of infrastructure, but in addition it enables the more efficient capture of heat.

Hydrogen for storage in the hydrogen storage sub-system 5 may be supplied for the purpose of energy storage from a number of sources. For example, power from the grid may be split for energy storage in both of the gravity-based energy storage sub-system 3 and the hydrogen storage sub-system 5 by a portion of the surplus power from the grid being diverted via branch power inlet 19 to preliminary electrolyser 21 to generate hydrogen which can be fed to the hydrogen energy storage sub-system 5, typically having passed through a compressor to pressurise the hydrogen to a pressure of up to a desired pressure or desired maximum pressure for storage in the hydrogen storage sub-system 5. The desired or maximum pressure may be any suitable pressure, e.g. up to 800 bar, or up to 400 bar, but preferably up to a 200 bar maximum, optionally a 100 bar maximum, such as about 85 bar. While a higher pressure will allow a greater quantity of hydrogen to be stored, it is an energy intensive exercise and will require additional infrastructure to achieve. By this arrangement, the hydrogen storage sub-system 5 can act as a supplementary system to the gravity-based energy storage sub-system 3 and has the effect of potentially increasing the power and capacity of the system 1. It also serves to enable a much larger amount of energy to be stored than the energy capacity of the gravity-based energy storage sub-system 3. Thus, electrical energy from the grid can be stored as potential energy in the gravity-based energy storage sub-system 3 and as chemical energy in the form of a fuel gas or energy carrier, such as hydrogen, in the hydrogen storage sub-system 5.

Optionally, hydrogen (as a fuel gas) may also be supplied to the system 1 from a hydrogen source from hydrogen system inlet connection 23 in order to be stored for future use. The inlet connection 23 may be supplied from any suitable hydrogen source, such as a hydrogen network pipeline (not shown), a hydrogen supply pipeline (not shown) (e.g. from a remote renewable hydrogen generation facility) or by tanker. The hydrogen supplied is typically passed through a compressor to pressurise the hydrogen gas to a level for storage, up to any suitable pressure, such as up to 250 bar, but for example about 85 bar, in the vessel of the hydrogen energy storage sub-system 5. Optionally, hydrogen supplied to the system 1 may be immediately supplied via branch hydrogen inlet to a preliminary fuel cell 27 (or other electrical generation apparatus, such as an engine) to generate electrical energy which may then be supplied to motor 15 to power winch 11 to store the energy thereof as potential energy in gravity-based energy storage sub-system 3. Alternative fuel gases can be used in the fuel gas storage sub-system, such as natural gas or methane or hydrocarbons like propane or butane.

Energy stored in the gravity-based energy storage sub-system 3 as potential energy may be converted to chemical energy to be stored in the hydrogen storage sub-system by supplying power from the gravity-based energy storage sub-system to intermediate electrolyser/compressor 29, which feeds the resultant pressurised hydrogen gas produced into the vessel of hydrogen storage sub-system 5. Thus, if the gravity energy storage sub-system 3 is almost at capacity (i.e. most of the weight in the system is raised), but capacity for further rapid response electrical energy storage is required or predicted, a portion of the energy stored in the gravity-based energy storage sub-system may be converted (or rather used to generate) hydrogen and stored in the hydrogen storage sub-system 5. Optionally, energy stored as chemical energy in the hydrogen storage sub-system 5 may be converted to potential energy stored in the gravity-based energy storage sub-system by supplying hydrogen from the hydrogen storage sub-system 5 to intermediate expander/fuel cell 31. Thus, if the gravity energy storage sub-system 3 is largely discharged (i.e. the weight is largely lowered) and/or if there is an expectation of a demand for power, the system 1 can be configured to increase the energy that may be available, with rapid response and rapid discharge, from the gravity-based energy storage sub-system 3. The ability to move energy from one energy storage form to the other within the system 1 enables a good degree of flexibility. Such flexibility allows energy to be stored according to the available capacity, predicted capacity requirements and output demands, as either potential energy in the gravity-based energy storage sub-system 3 or chemical energy in the form of hydrogen in the hydrogen storage sub-system 5 and optionally to re-balance energy storage levels between the two sub-systems. A control system (not shown) may be configured to control energy storage arrangements between the two system to facilitate priorities of meeting demand for storage (which may be a rapid storage requirement, both in terms of response time and storage speed), quantity of energy storage required, predicted output demands (nature, speed and amounts of energy to be output) and efficiency of energy storage (by which the exchange of energy between storage forms should be minimised).

Typically, the system 1 is provided with a system gas output connector 33 to supply hydrogen to an output hydrogen demand, such as a hydrogen gas network or a gas network (e.g. natural gas/methane) into which hydrogen may be injected at a pre-defined percentage, which may be a local network, or to a tanker for transport or other hydrogen gas usage (e.g. as a feedstock). System gas output connector 33 is fed from vessel outlet 35 via expander 37.

In one embodiment, the system 1 may accommodate or supply a vehicle charging/fuelling station 39 for recharging electric or hybrid electric vehicles and/or refuelling hydrogen or hybrid hydrogen vehicles (e.g. cars, trucks, buses or trains). Thus, optionally, the system 1 may comprise a charge station power outlet connection 41 and/or a refueller hydrogen outlet 43.

Optionally, there may be provided a gas-to-power converter and/or a power-to-gas convertor (not shown) downstream of each of the first and second energy storage sub-systems for supplying corresponding electrical power outlets 17,41 from the hydrogen storage sub-system or for supplying the hydrogen outlets 33,43 from the gravity-based energy storage sub-system 3.

Preferably a thermal energy capture and storage sub-system 7 (the thermal energy system) is integrated into system 1. The thermal energy system 7 may typically comprise a thermal energy store 45, such as a water tank (or other thermal energy carrier liquid tank) or phase change material, which may store energy collected via a thermal energy collection loops or circuits 47 which collects thermal energy, typically via a circulating fluid, from preliminary fuel cell 27 and electrolyser 21, intermediate electrolyser/compressor 29 and intermediate fuel cell and expander 31 and from motor 15 and winch 11. A ground source heat loop/exchanger 49 may typically be disposed about the periphery of the vertical passageway or shaft of gravity-based energy storage sub-system 3 to collect ground source heat from the surrounding materials and/or disposed inside or in relation to the storage vessel of hydrogen storage sub-system 5 in order to collect heat from within the hydrogen storage vessel. By collecting the heat in operating motors and components and in collecting heat from with in a vertical passageway/shaft and/or hydrogen storage vessel, to be used elsewhere, the effective efficiency of storage of energy in the system 1 is increased. Thermal energy stored in thermal energy store 45 may be used in any suitable way, for example by export via heat demand circuit 51. This may be to a district heating scheme, to a neighbouring industrial (low grade) heat user or a heat to power converter (such as a thermoelectric generator) to feed back into powering motor 15.

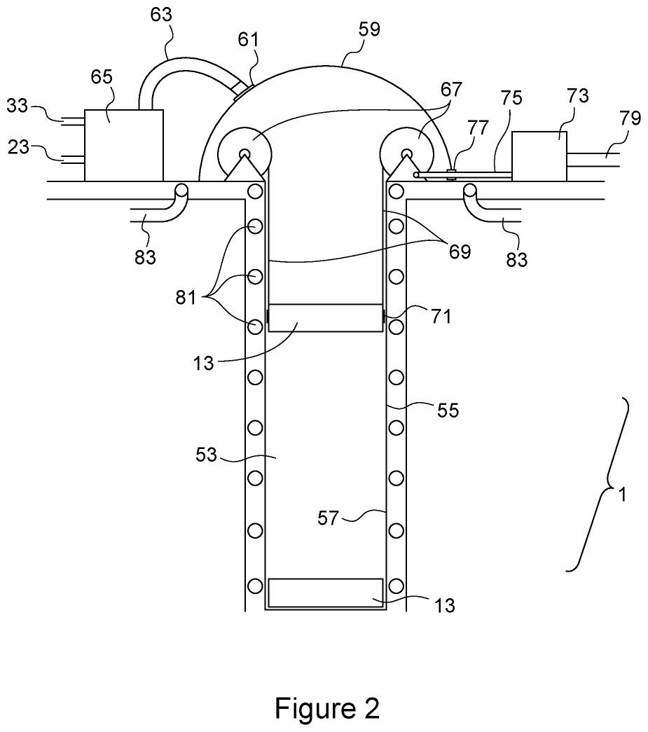

In FIG. 2, which illustrates in cross-sectional view an energy storage system 1 of a preferred embodiment, a hydrogen energy storage sub-system encompasses the vertical passage or shaft 53 of the gravity-based energy storage sub-system. The hydrogen storage sub-system consists of storage vessel 55, which includes the shaft 53, which has a lining 57 formed of steel (or a concrete lining or other materials) optionally with a coating for protecting the steel lining from embrittlement from hydrogen gas, and a dome 59 disposed over the top of shaft 53 to complete the vessel 55. The lining 55 extends about the top of shaft 53 to the boundary with the dome 59. Hydrogen may be pumped into and out of the vessel 55 via a valve 61 disposed in the dome 59 linked by a pressurised supply pipe 63 to compressor/expander 65 to hydrogen system inlet connection 23 and system hydrogen output connection 33.

The gravity-based energy storage sub-system comprises multiple weights 13 (two shown here), which may be winched from a lower position to an upper position in order to store energy and lowered from an upper position to a lower position to release energy. Winches 67 are provided with synthetic cable 69 (of material resistant to hydrogen embrittlement) that are connected to the sides of weights 13 by way of linking members 71. The winches 67 are hydraulically driven by (and hydraulically drive) a hydraulic motor/generator 73 disposed outside the storage vessel 55 and linked to the winches 13 by way of hydraulic cables 75 which pass through a sealed aperture 77 in the dome 59. The hydraulic motor/generator 73 is connected to grid input/output connection 79.

Behind or within lining 57 and preferably in thermally conductive communication with the lining is heat exchange element 81 of a cooperating thermal energy collection circuit 83. The heat exchange element 81 may be used to collect ground source heat from the materials surrounding the shaft and any heat from within the shaft 53. It may also be used to modulate heat variation in the shaft 53 to enhance the efficiency of the storage of hydrogen. Optionally, a thermal energy collection circuit 83 may also be linked to hydraulic motor/generator 73 and compressor/expander 65 in order to capture lost heat. By capturing and using the heat generated by components such as the motor/generator 73 and compressor/expander 65, the overall efficiency of energy storage in the system 1 can be improved and still further improved by utilising the geothermal energy accessible via the shaft walls via a ground source collector. Optionally, the collected thermal energy may be stored, used by a local heat user, or converted to electrical energy and provided as an input into hydraulic motor 73.

Potential energy stored by raised weights 71 may be converted to chemical energy by using the output from the generator 73 when lowering weights to power an electrolyser (not shown) to generate hydrogen gas, which may be fed into compressor 65 and stored as compressed hydrogen at a pressure of, for example, 85 bar, thereby significantly multiplying the energy storage capacity of a system 1, while maintaining its rapid response and fast charge/discharge capability (associated with the gravity-based energy storage sub-system) and, with the option to retain the round trip storage efficiency of the gravity-based energy storage sub-system when the charge-discharge cycle requirement is within its capacity. The opposite conversion may also be facilitated.

The hydrogen energy storage sub-system significantly expands the energy storage capacity of the system. For example, using a 500 m deep hole or shaft with a 6 m in diameter and a single 1000 tonne weight, the gravity-based energy storage sub-system has an energy storage capacity of about 1.2 MWh. When the same space is filled with hydrogen at 50 bar, it has a calorific value of about 1,800 MWh and, even allowing for a generator that is only 30% efficient, will produce at least 500× as much electrical energy as one descent of the weight. In other words, stored hydrogen in pressurized form can increase the capacity to raise the weight about 500 times and thereby multiplies the storage capacity of the system by a factor of about 500 (assuming all the gas can be used but, of course the pressure will drop to some minimum acceptable level before it is all used).

The system provides a combined storage system with rapid response capable of providing grid stability with reserves of electrical energy (converted from gas) that are much greater than any other storage system that could be deployed on a distributed basis.

Thus, the system 1, controlled by a controller to manage the balance of energy storage between the sub-systems in the most efficient and/or effective manner (depending upon the priorities at a particular time) provides a flexible energy storage solution, for both gas and electrical energy with efficiency enhanced by effective thermal collection and storage/use.

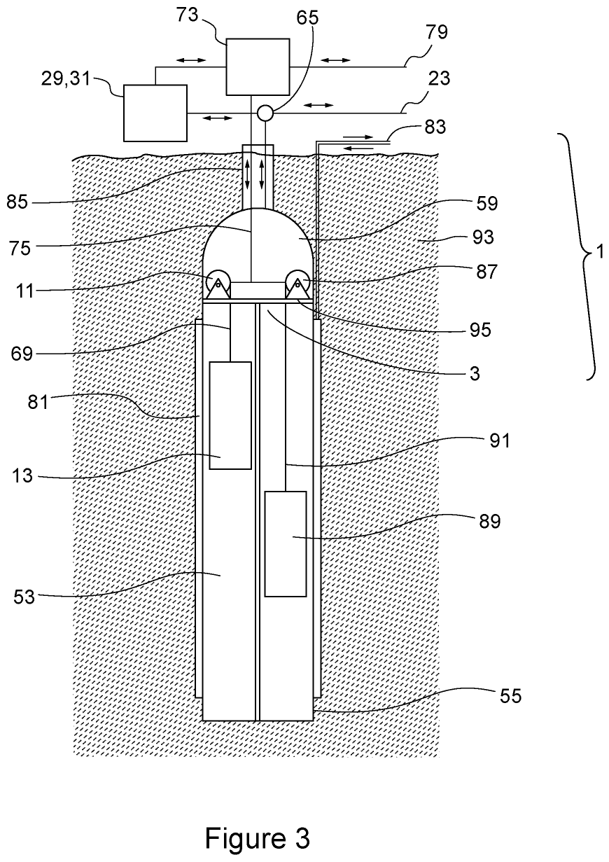

In FIG. 3, an alternative embodiment of an energy storage system 1 is illustrated in which a vertical passageway or shaft 53 in the ground 93 is provided for a multi-weight gravitational energy storage sub-system 3, which shaft volume is defined by a vessel 55 having dome/cap 59 sealing the top and also provided in the ground 93 for containing a fuel gas such as hydrogen as part of a fuel gas storage sub-system. The multi-weight gravity storage sub-system 3 shaft 53 and vessel 55 occupy or define the same volume, leading to shared infrastructure and cost and land efficiencies.

The multi-weight gravity energy storage system 3 according to one embodiment comprises a first winch arrangement 11 disposed on a platform 95 within the shaft 53 from which is suspended via a first synthetic cable 69 a first weight 13 and a second winch arrangement 87 disposed on the platform 95 from which is suspended via a second synthetic cable 91 a second weight 89. The winches 11,87 are operated by hydraulic motors/pumps (not shown) inside the vessel 55 driven by hydraulic fluid supplied via hydraulic pipes 75 extending through a sealed service linkage 85 via sealed apertures from hydraulic motor/generator 73. The hydraulic motor/generator is supplied with power from an external electrical grid via inlet/outlet 79. In use, when the grid has excess energy, power is supplied via inlet/outlet 79 to hydraulic motor 73, which pumps fluid through hydraulic pipe 75 to drive winch motors causing one or other or both of the winches 11,87 to raise their weights 13,89. When there is a desire to export energy to the external grid, the weights 13,89 may be allowed to drop, causing winches 11,87 to pump hydraulic fluid via hydraulic fluid pipes 75 through sealed service linkage 85 to hydraulic generator 73, to generate electrical energy that is exported via power input/output connector 79. The raising and lowering of weights 13,89 is controlled by a controller (not shown) according to the requirements of an external grid, for example.

Hydrogen (or other fuel gas in some embodiments) may be stored in the vessel 55 in which the winches and weight arrangements are disposed at any suitable pressure (e.g. up to 800 bar, but preferably up to 400 bar and more preferably up to 100 bar, e.g. up to a max of about 85 bar). Hydrogen may optionally be supplied from an external hydrogen source via hydrogen input/output connection 23 and after storage may optionally be exported via input output connection 23 to an external hydrogen user, such as by injection into a natural gas network, or local hydrogen network or to a hydrogen refuelling station. Hydrogen supplied from an external hydrogen network may be supplied via a hydrogen inlet pip passing through sealed service linkage 85, after having passed through compressor/expander 65, to be stored in the vessel 55.

When the stored potential energy in the weights 13,89 is at its maximum or nears its maximum, or when the controller or control software predicts or expects a significant demand for electrical power storage, the system 1 may be caused to convert the form of stored energy from potential energy to chemical energy (in the form of hydrogen). This is achieved by allowing the weights 13,89 to be lowered within the shaft/vessel 53,55 creating electrical energy, in the manner described above, at generator 73 and the resulting electrical energy supplied to electrolyser 29 to form hydrogen gas (from water) which may then be compressed via compressor 65 and stored back in the same vessel 55. Similarly, if there is predicted need for electrical energy, or more particularly an expected need for rapid, e.g. black start, power to an external grid at a time where the weights 13,85 are close to the bottom of the shaft 53, hydrogen from the vessel 55 may be supplied via a gas supply pipe through sealed service linkage 85 and expander 65 to a fuel cell 31 to provide electrical energy which may be used to run hydraulic motor 73 to power winches 11,87 and raise weights 13,89 in the shaft to be stored as readily deployable potential energy.

To further enhance the efficiency and flexibility of the system 1, a thermal energy storage sub-system comprises a heat exchange element is provided about the shaft 53 for collecting ground source heat from the ground 93 outside of the shaft/vessel, 53,55 and to collect any heat from inside the vessel 55 (e.g. as a result of pressure changes). This heat may be exported via thermal energy collection circuit 83 to a thermal energy store (not shown) or external use (e.g. district heating scheme). Thus, a flexible and efficient energy storage system can be provided in a single shaft which provides heat, fuel and power according to the needs of an external system.

The invention has been described with reference to a preferred embodiment. However, it will be appreciated that variations and modifications can be effected by a person of ordinary skill in the art without departing from the scope of the invention.

1. An energy storage system comprising:
a first energy storage sub-system comprising a gravity-based energy storage system comprising at least one weight movable between a first upper position and a second lower position, the first upper and second lower positions defining a vertical displacement for the or each weight;
a second energy storage sub-system comprising a vessel for storage of a pressurized fuel gas;
an electrical input connection and an electrical output connection with an external power system; and
at least one of:
a fuel gas inlet for supply of a fuel gas to the energy storage system from an external fuel gas supply or network; and
a fuel gas outlet for supply of a fuel gas from the energy storage system to an external fuel gas user or network; and/or
at least one of:
a gas to power conversion arrangement for converting energy from fuel gas to electrical energy for storage in the first energy storage sub-system or export to an external power system via the electrical output connection; and
a power to gas conversion arrangement for converting electrical energy to a fuel gas for storage in the second energy storage sub-system or export to an external fuel gas user or network via a fuel gas outlet;
wherein the energy storage system further comprises a control system for controlling cooperative or complimentary operation of the first and second energy storage sub-systems according to the requirements of the external power system and/or external fuel gas network or user.

2. An energy storage system as claimed in claim 1, wherein the first energy storage sub-system comprises a vertical passageway or shaft through which the at least one weight is movable between the first upper position and second lower position, and wherein the vessel of the second energy storage sub-system comprises the shaft of the first energy storage sub-system.

3. An energy storage system as claimed in claim 2, wherein the first energy storage sub-system comprises a shaft formed in the ground.

4. An energy storage system as claimed in claim 3, wherein the first energy storage sub-system comprises a winch and cable arrangement, which comprises at least one winch disposed at or in relation to a shaft opening at the top of the shaft, whereby a cable may be wound and unwound by the winch to enable raising and lowering the weight, and wherein the winch and cable arrangement is disposed within the vessel.

5. An energy storage system as claimed in claim 4, wherein the vessel comprises a cap or dome disposed and sealed over the top of the shaft.

6. An energy storage system as claimed in claim 4, wherein the winch and cable arrangement is hydraulically driven by an hydraulic drive means, when the first energy storage sub-system is receiving power or charging, and hydraulically drives an hydraulic generator, when the first energy storage sub-system is discharging power or discharging, wherein the hydraulic drive means and hydraulic generator is disposed outside the vessel of the second energy storage sub-system and wherein hydraulic drive feed and return pipes linking the hydraulic drive means and hydraulic generator with the winch and cable arrangement passes through an aperture formed in the vessel wall, wherein a seal is formed at the vessel wall around the pipes to prevent leakage of pressurized gas from the interior of the vessel to the surrounding atmosphere.

7. An energy storage system as claimed in claim 1, the system further comprising a thermal capture and/or storage sub-system configured to capture thermal energy from within and/or material surrounding the vessel of the second energy storage sub-system.

8. An energy storage system as claimed in claim 7, wherein the thermal capture and/or storage sub-system comprises a heat pump arrangement.

9. An energy storage system as claimed in claim 7, wherein the thermal capture and/or storage sub-system is configured to provide heating and/or cooling to the fuel gas storage sub-system vessel via a thermal exchange element to maintain a temperature of the fuel gas storage vessel within pre-defined operational limits.

10. An energy storage system as claimed in claim 1, wherein the fuel gas is hydrogen or methane or propane or natural gas.

11. An energy storage system as claimed in claim 10, wherein the fuel gas is hydrogen.

12. An energy storage system as claimed in claim 10, wherein the fuel gas is stored in the vessel at a pressure of a maximum of about 85 bar.

13. An energy storage system as claimed in claim 1, wherein the first energy storage sub-system comprises a multi-weight gravity-based energy storage arrangement comprising a shaft and multiple weights configured for lowering and raising through the shaft by a transporter and to be stored in storage positions at the top and/or bottom of the shaft.

14. An energy storage system as claimed in claim 13, wherein the first energy storage sub-system has a primary energy capacity and is characterized by discontinuities in power flow capability.

15. An energy storage system as claimed in claim 13, which comprises a third energy storage sub-system configured for cooperative and/or complimentary operation with the first energy storage sub-system in order to provide the energy storage system with one or more of:
i) a continuous input or output power during a charge or discharge cycle across at least two energy events of the first energy storage sub-system which energy events are separated by a discontinuity in output from the first energy storage sub-system;
ii) an enhanced or faster system start-up response, whereby the system may reach a predefined or desired power input/output level by responding to a requirement of an external power system using both the primary energy storage arrangement and the secondary energy storage arrangement simultaneously for the requirement of the external power system;
iii) an enhanced system discharge halting capability, whereby the system may rapidly halt discharge to an external power system without a power output surge above a desired system power output, the power output surge being directed for temporary energy storage in the secondary energy storage arrangement; and
iv) a power surge input/output capability, whereby for short durations, the system can input or output power at a power level above a power rating of the energy storage system or the primary power storage arrangement.

16. An energy storage system as claimed in claim 15, wherein the system has a system power rating being the maximum power the system can input/output to/from an external power system.

17. An energy storage system as claimed in claim 16, wherein the third energy storage sub-system has a tertiary power rating at least equal to the system power rating and has a tertiary energy capacity at least equal to a maximum energy gap arising from a discontinuous nature of the first energy storage sub-system power input/output when the system power input/output is constant at the system power rating.

18. An energy storage system as claimed in claim 17, wherein the tertiary energy capacity is up to 10 times the maximum energy gap.

19. An energy storage system as claimed in claim 17, wherein the primary power rating is greater than the tertiary power rating.

20. An energy storage system as claimed in claim 15, wherein the third energy storage sub-system is selected from a battery, a capacitor or supercapacitor, a compressed air energy storage system, a flywheel or a second gravity-based energy storage system.

21. (canceled)

22. An energy storage system as claimed in claim 1, which comprises a vehicle charging and/or refuelling station which comprises an eV charging station and/or a fuel gas vehicle refuelling station, the vehicle charging and/or refuelling station being supplied from the energy storage system via a vehicle charge station electrical supply connection and/or a refuelling fuel gas outlet connection.

23. An energy storage system comprising:
a first energy storage sub-system comprising a gravity-based energy storage system comprising at least one weight movable between a first upper position and a second lower position through a volume defined by a shaft formed in the ground, the first upper position and the second lower position defining a vertical displacement for the at least one weight; and
a second energy storage sub-system comprising a pressurized fuel gas storage vessel, the vessel defining a fuel-gas storage volume which encompasses the volume defined by the shaft of the first energy storage sub-system.

24. An energy storage system comprising:
a first energy storage sub-system comprising a gravity-based energy storage system comprising at least one weight movable between a first upper position and a second lower position through a shaft formed in the ground, the first upper position and the second lower position defining a vertical displacement for the at least one weight; and
a thermal energy capture and/or storage sub-system comprising heat capture elements disposed within or surrounding the shaft of the first energy storage sub-system to capture thermal energy from within or surrounding the shaft.

25. A method for the storage and supply of energy to and from external energy systems, the method comprising providing an energy storage system as defined in claim 1, operating the control system to control the storage of electrical energy from an external power source or network as potential energy by the raising of the at least one weight of the first storage sub-system or chemical energy by conversion of the electrical energy to a fuel gas by way of the power to gas conversion arrangement and storing the fuel gas in the second energy storage sub-system to control the storage of energy from fuel gas from an external fuel gas supplier or network as compressed fuel gas by feeding the fuel gas into the second energy storage arrangement or storing the supplied fuel gas as potential energy by conversion of the fuel gas to electrical energy using a gas to power conversion arrangement and storing the energy as potential energy by the raising of weights in a first storage sub-system in accordance with the energy storage requirements of external gas and power networks or suppliers and in dependence of the fuel gas and electrical energy storage capacity of the first and second energy storage sub-systems and pre-defined or predicted fuel gas and electrical energy output requirements.
